(19) United States
(12) Patent Application Publication
(10) Pub. No.: US 2015/0281317 A1
(43) Pub. Date: Oct. 1, 2015

(54) REQUESTING MEDIA CONTENT SEGMENTS VIA MULTIPLE NETWORK CONNECTIONS

(71) Applicant: Google Inc., Mountain View, CA (US)

(72) Inventors: Hao Du, San Jose, CA (US); Andreas Terzis, Mountain View, CA (US); Ankur Jain, Mountain View, CA (US)

(21) Appl. No.: 14/645,105

(22) Filed: Mar. 11, 2015

Related U.S. Application Data
(60) Provisional application No. 61/972,895, filed on Mar. 31, 2014.

(51) Int. Cl. H04L 29/06; H04L 12/26

(52) U.S. Cl. CPC H04L 65/80; H04L 65/602; H04L 43/0888

(57) ABSTRACT

Systems and methods are disclosed for requesting media content segments via multiple network connections. In one implementation, a processing device requests, via a first network connection, a sequential transfer of a first media content segment in a first direction. The processing device requests, via a second network connection, a sequential transfer of the first media content segment in a second direction. The processing device requests, based on a determination that the first media content segment has been received, from at least one of the first network connection or the second network connection, a second media content segment.

### CROSS-REFERENCE TO RELATED APPLICATION

This application is related to and claims the benefit of U.S. Patent Application No. 61/972,895, filed Mar. 31, 2014, the entirety of which is incorporated herein by reference.

### TECHNICAL FIELD

Aspects and implementations of the present disclosure relate to data processing, and more specifically, to requesting media content segments via multiple network connections.

### BACKGROUND

Audio and video content can be stored on data servers and provided to users for listening/viewing over the Internet. Applications for supporting the listening/viewing of such audio and video content may be browser-based, or may run independently of a browser.

### SUMMARY

The following presents a simplified summary of various aspects of this disclosure in order to provide a basic understanding of such aspects. This summary is not an extensive overview of all contemplated aspects, and is intended to neither identify key or critical elements nor delineate the scope of such aspects. Its purpose is to present some concepts of this disclosure in a simplified form as a prelude to the more detailed description that is presented later.

In an aspect of the present disclosure, a processing device requests, via a first network connection, a sequential transfer of a first media content segment in a first direction. The processing device requests, via a second network connection, a sequential transfer of the first media content segment in a second direction. The processing device requests, based on a determination that the first media content segment has been received, from at least one of the first network connection or the second network connection, a second media content segment.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one implementation of the present disclosure.

FIG. 2 depicts a flow diagram of aspects of a method for requesting media content segments via multiple network connections.

FIG. 3 depicts an exemplary media content item, in accordance with one implementation of the present disclosure.

FIG. 4 depicts an exemplary media content item, in accordance with one implementation of the present disclosure.

FIG. 5 depicts an exemplary media content item, in accordance with one implementation of the present disclosure.

FIG. 6 depicts a block diagram of an illustrative computer system operating in accordance with aspects and implementations of the present disclosure.

### DETAILED DESCRIPTION

Aspects and implementations of the present disclosure are directed to requesting media content segments via multiple network connections. The systems and methods disclosed can be applied to media content such as audio and/or video content, images, and/or any other content or data that can be collected and/or disseminated such as via a media sharing service or website. More particularly, many devices, such as those through which users can view media content (e.g., smartphones, tablet computers, etc.) incorporate multiple communication/network interfaces. Examples of such interfaces include but are not limited to: WiFi (i.e., 802.11), 3G/4G cellular networks, Bluetooth, etc. In many scenarios, mobile operating systems and/or applications may dictate which of the available network interfaces are to be utilized (e.g., when requesting/receiving data such as media content). However, in certain scenarios such a default option may be suboptimal (e.g., in a scenario in which the internet access provided by a WiFi router is slow/unreliable). Moreover, by utilizing only a single interface, a viewer may need to wait longer in order to allow a video to load/buffer, despite the fact that other network interfaces are available at the device.

Accordingly, described herein in various embodiments are technologies that enable requesting media content segments via multiple network connections. For example, as described herein, a media content segment (e.g., a segment of a video) can be requested, substantially simultaneously, using multiple network connections (e.g., WiFi and 3G/4G). One network connection can be utilized to request/receive the media content segment in one direction (e.g., in a sequence starting at the beginning of the media content segment and progressing towards the end of the segment) while the other network connection can be utilized to request/receive the same media content segment in another direction (e.g., in a sequence starting at the end of the media content segment and progressing towards the beginning of the segment). In doing so, multiple network connections/interfaces can be utilized to request/receive a media content item in a relatively more expedient and efficient manner than by utilizing only a single network connection. Moreover, being that the speed, quality, latency, etc., of a particular network connection can change over time and/or based on different circumstances, the speed, etc., of each connection can be monitored on a regular basis. In doing so, the connection that is presently/most recently the fastest can be identified, and this connection can be utilized to request/receive a subsequent media content segment in a particular direction (e.g., from beginning to end). In doing so, each segment can be loaded in a manner in which the earlier part of the segment is loaded via the (current) fastest connection, thereby reducing the buffering/loading delays for the viewer. Additionally, utilizing multiple network connections can improve the overall reliability of data transfers (e.g., of media content). For example, in scenarios in which one network may experience a temporary (or permanent) loss of reliability, another network can be utilized, thereby improving the overall reliability of the content transfer.

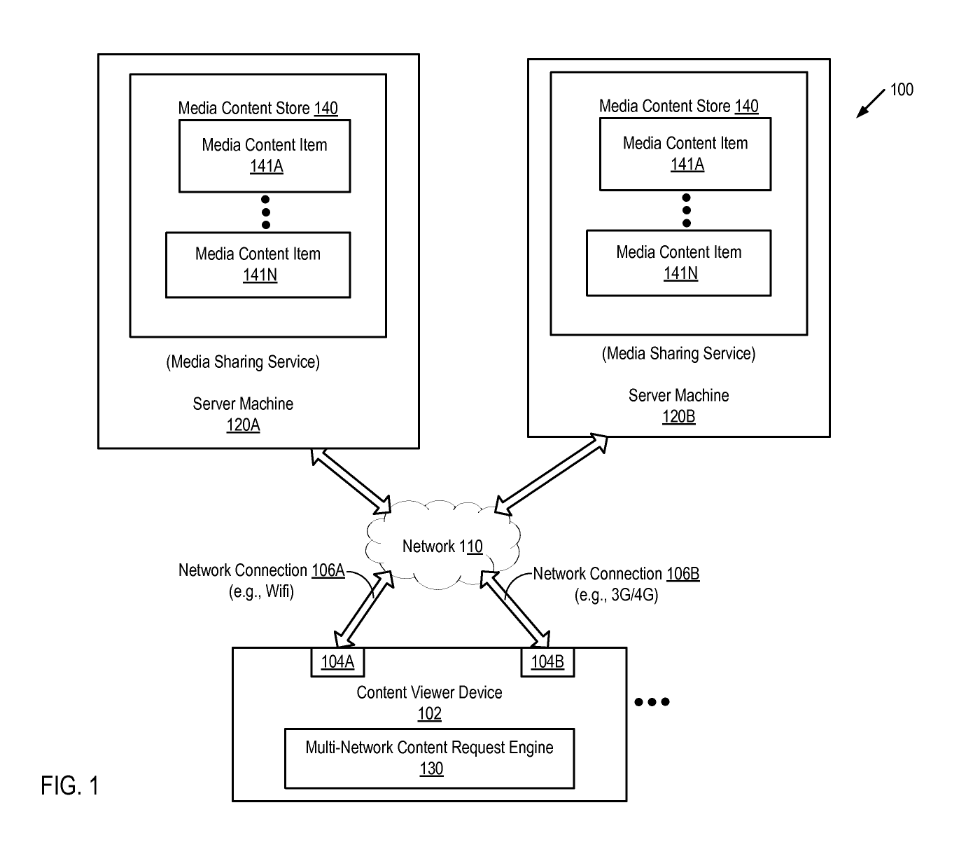

FIG. 1 depicts an illustrative system architecture 100, in accordance with one implementation of the present disclosure. The system architecture 100 includes content viewer device 102 and server machines 120A-120B. These various elements or components can be connected to one another via network 110, which can be a public network (e.g., the Internet), a private network (e.g., a local area network (LAN) or wide area network (WAN)), or a combination thereof.

Content viewer device 102 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. In certain implementations, content viewer device 102 can enable a user, such an individual to interact with one or more services (e.g., media sharing services, social networks, etc.) such as in order to view and/or or otherwise interact with various media content items and/or related content. Additionally, content viewer device 102 may run an operating system (OS) that manages hardware and software of the content viewer device 102. Various applications, such as mobile applications (‘apps’), web browsers, etc. (not shown) may run on the content owner device (e.g., on the OS of the content owner device). Such applications can, for example, enable a user to capture media content (e.g., an audio clip, a video clip, etc.), provide media content (e.g., upload media content to a central server and/or transmit it to another user), receive media content (e.g., via network 110), and/or view, display, or otherwise present media content (e.g., playing a video, listening to a song, etc.), such as via the content viewer device 102.

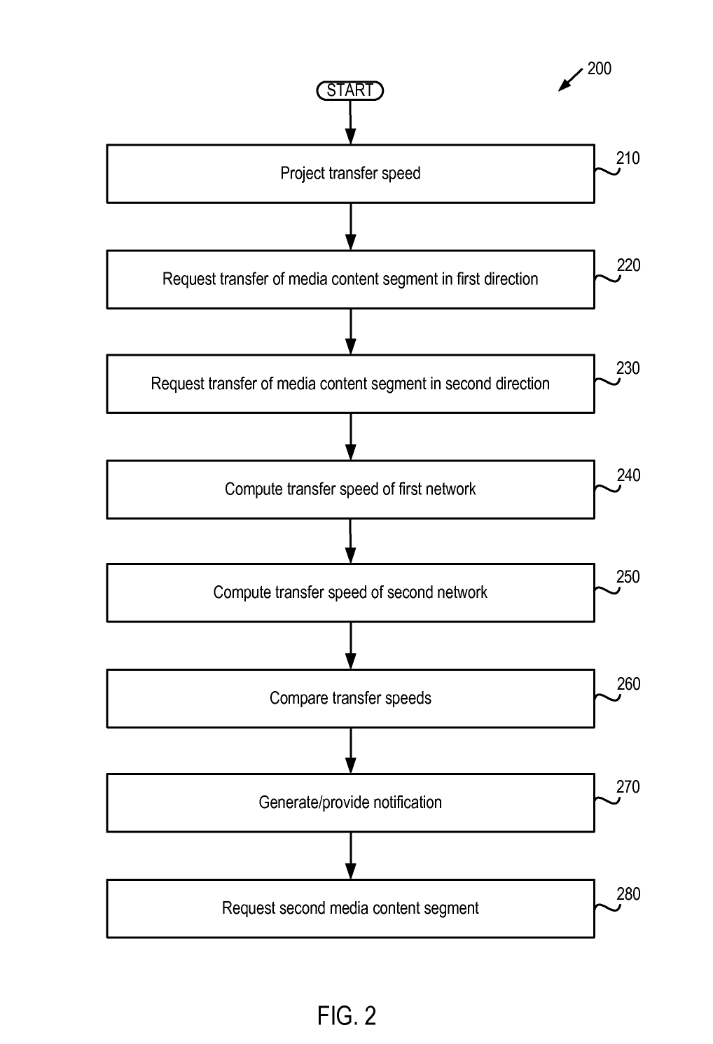

In certain implementations, content viewer device 102 can include and/or otherwise incorporate one or more communication interfaces 104A-104B. Such communication interfaces can be one or more elements or components that enable the device 102 to communicate with one or more other systems, machines, etc., such as by using one or more communication protocols to establish one or more connections 106A-106B. Examples of such communication interfaces include but are not limited to WiFi (i.e., 802.11), 3G/4G cellular, Bluetooth, etc. Content viewer device 102 can include components such multi-network content request engine 130. The components can be combined together or separated in further components, according to a particular implementation. It should be noted that in some implementations, various components of the content viewer device(s) 102 may run on separate machines. Moreover, some operations of certain of the components are described in more detail below with respect to FIG. 2.

Each of server machine 120 can be a rackmount server, a router computer, a personal computer, a portable digital assistant, a mobile phone, a laptop computer, a tablet computer, a camera, a video camera, a netbook, a desktop computer, a media center, any combination of the above, or any other such computing device capable of implementing the various features described herein. Server machine(s) 120 can include components such as media content store 140. It should also be noted that while server machines 120A and 120B are depicted and described herein as separate servers/machines, in certain implementations a single server (or set of servers) can be employed (and thus transfers of media content items 141 would be routed to/from such a server.

Media content store 140 can be hosted by one or more storage devices, such as main memory, magnetic or optical storage based disks, tapes or hard drives, NAS, SAN, and so forth. In some implementations, media content store 140 can be a network-attached file server, while in other implementations media content store 140 can be some other type of persistent storage such as an object-oriented database, a relational database, and so forth, that may be hosted by the server machine 120 or one or more different machines coupled to the server machine 120 via the network 110, while in yet other implementations media content store 140 may be a database that is hosted by another entity and made accessible to server machine 120.

Media content store 140 can include media content items 141A-141N. In certain implementations, media content items 141A-141N can correspond to media content itself (e.g., audio clips, video clips, images, etc.) and can be provided, for example, by a content owner. Moreover, in certain implementations, server machine 120 can be configured to allow full and/or substantially unlimited access to such media content items. Accordingly, users wishing to access or view such media content items via the media sharing service can be enabled, under most circumstances, to do so.

It should be understood that though FIG. 1 depicts server machine(s) 120 and device 102 as being discrete components, in various implementations any number of such components (and/or elements/functions thereof) can be combined, such as within a single component/system.

As described herein, a media content segment (e.g., a segment of a video) can be requested, substantially simultaneously, using multiple network connections (e.g., WiFi and 3G/4G). One network connection can be utilized to request/receive the media content segment in one direction (e.g., in a sequence starting at the beginning of the media content segment and progressing towards the end of the segment) while the other network connection can be utilized to request/receive the same media content segment in another direction (e.g., in a sequence starting at the end of the media content segment and progressing towards the beginning of the segment). In doing so, multiple network connections/interfaces can be utilized to request/receive a media content item in a relatively more expedient and efficient manner than by utilizing only a single network connection. In certain implementations, such operations can be performed by and/or in conjunction with multi-network content request engine 130.

FIG. 2 depicts a flow diagram of aspects of a method 200 for requesting media content segments via multiple network connections. The method is performed by processing logic that may comprise hardware (circuitry, dedicated logic, etc.), software (such as is run on a general purpose computer system or a dedicated machine), or a combination of both. In one implementation, the method is performed by content viewer device 102 of FIG. 1, while in some other implementations, one or more blocks of FIG. 2 may be performed by another machine. For example, in various alternative implementations, the method can be performed by/at server machine 120.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At block 210, a transfer speed can be projected. In certain implementations, such a transfer speed can be a transfer speed of a first network connection (e.g., a WiFi network connection) and/or a second network connection (e.g., a cellular network connection). For example, with respect to a content viewer device 102 (e.g., smartphone, tablet computer, etc.) having multiple network connections (e.g., network connection 106A via communication interface 104A of the device 102, network connection 106B via communication interface 104B of the device 102, such as is shown in FIG. 1) one or more of the network connections can be tested and/or analyzed (e.g., based on current and/or past network performance) in order to project a transfer speed for each network connection. For example, it can be determined by recording the time a data packet is transmitted to a destination via a first network connection and the time a ping is received indicating that the data packet has reached the destination. In one aspect, block 210 is performed by multi-network content request engine 130.

At block 220, a sequential transfer of a first media content segment can be requested. For example, upon receiving a selection of a media content item 141 such as a streaming video (e.g., as stored/provided by a media sharing service 120), a request for a transfer of a segment of such a media content item can be generated and/or provided by content viewer device 102. In certain implementations, such a transfer can be requested via a first network connection (e.g., a WiFi network connection, such as network connection 106A, as depicted in FIG. 1). In one aspect, block 220 is performed by multi-network content request engine 130.

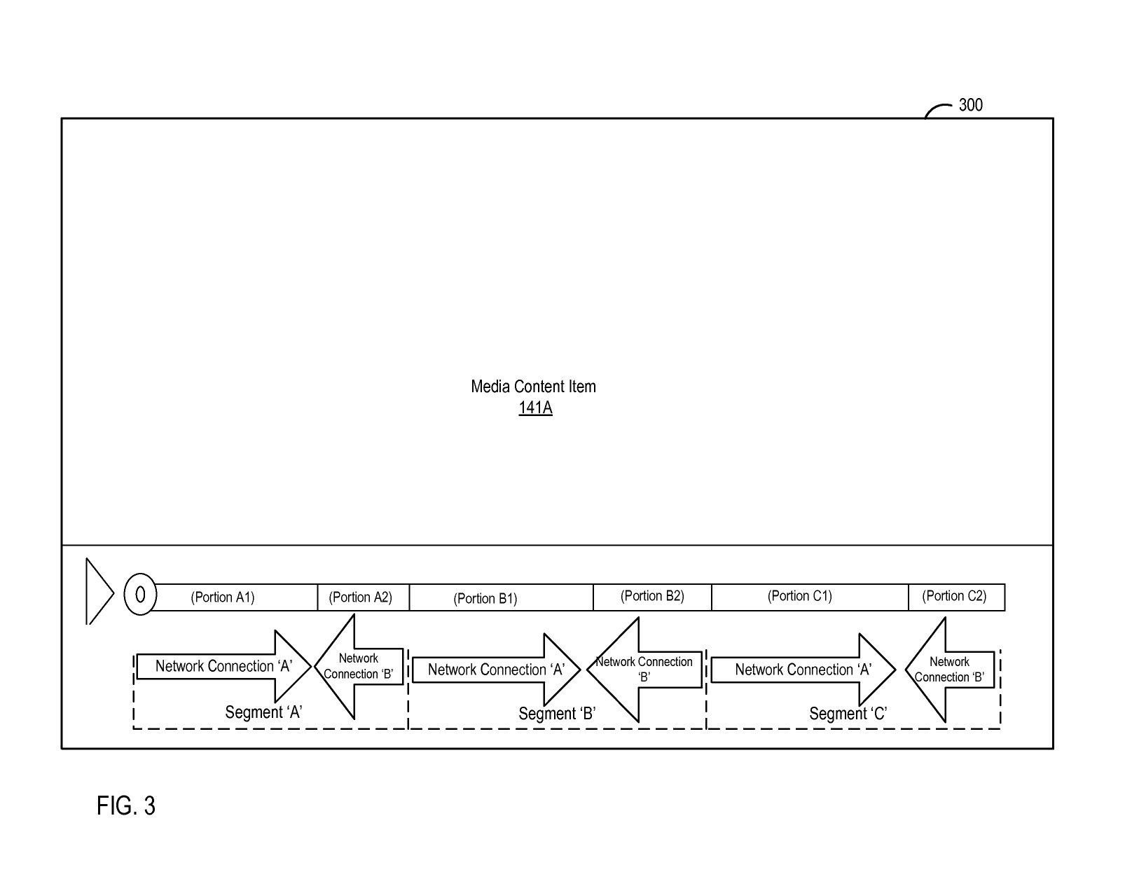

Moreover, in certain implementations, such a sequential transfer of a first media content segment can correspond to a first direction. That is, it can be appreciated that various media content items, such as those that are played/presented in a chronological sequence (e.g., audio and/or video content that is played, e.g., from the beginning of a clip to an end of a clip) can be delivered or ‘streamed’ in a sequential manner, such that content to be played earlier in the sequence can be delivered prior to content to be played later in the sequence. Accordingly, having received a selection of a media content item at device 102, a first segment of such a media content item can be requested. By way of illustration, FIG. 3 depicts an exemplary media player 300 (e.g., a media player embedded and/or otherwise incorporated within a webpage, a standalone media player application that can execute on a mobile device, etc.) in which media content item 141A has been selected to be played. As shown in FIG. 3, the duration of the media content item can be divided into several segments (segment ‘A,’ segment ‘B,’ and segment ‘C’). Upon receiving a selection of the media content item, the first segment (e.g., segment ‘A’) can be requested in a particular direction (e.g., from the beginning of the segment forward, as shown in FIG. 3) via network connection ‘A’ (e.g., a WiFi connection). In doing so, at least a portion of the segment (e.g., portion A1 of segment ‘A,’ as depicted in FIG. 3) can be requested and/or received via network connection ‘A.’

Additionally, in certain implementations, a first portion of the first media content segment can be requested/received from a first media source via the first network connection. That is, while in certain implementations a media content item may be stored in a single network location (e.g., on a single server which may be accessed via multiple network connections), in other implementations multiple copies of the same media content item (e.g., media content item 141A as shown in FIG. 3) can be stored on multiple servers. For example, as depicted in FIG. 1, server machine 120A and server machine 120B can both store the same media content items. As such, it should be understood that the referenced portion of the media content segment being received (e.g., via network connection ‘A’) may be requested/received from one of such servers (e.g., server machine 120A).

Moreover, in certain implementations, the sequential transfer of a first media content segment in a first direction can be requested based on a projected transfer speed (e.g., of one or more network connections). That is, having projected (e.g., at block 210) the transfer speed of one or more network connections (e.g., network connections 106A and 106B), the sequential transfer of a first media content segment in a first direction (e.g., from the beginning of segment ‘A’ forwards, as shown in FIG. 3) can be requested via the network connection determined/projected to be relatively faster (e.g., network connection ‘A’). Being that this portion of the media content segment (e.g., portion A1, as shown in FIG. 3) is likely to be played first, it can be advantageous to utilized the network connection projected to be relatively faster to load this portion of the segment, in order to begin playing the segment as quickly as possible (thereby minimizing loading/buffering time for the viewer).

At block 230, a sequential transfer of the first media content segment in a second direction can be requested. For example, substantially concurrent with the request/receipt of the first media content segment in the first direction (e.g., upon receiving a selection of the media content item, such as is described at block 220), a request for a transfer of substantially the same segment (e.g., segment ‘A,’ as shown in FIG. 3) can be generated and/or provided (e.g., by content viewer device 102) via another network connection (e.g., a 3G/4G cellular network connection, such as network connection 106B, as depicted in FIG. 1). It should be understood that while, in certain implementations, the referenced requests, transfers, etc., can occur substantially concurrently, in other implementations an initial request can be provided (e.g., with respect to one network connection) and this request can subsequently be followed by another request (e.g., of another network connection), such as is described in greater detail with respect to block 240. In one aspect, block 230 is performed by multi-network content request engine 130.

Moreover, in certain implementations, such a sequential transfer of the first media content segment (e.g., segment ‘A’ as depicted in FIG. 3) in a second direction can be requested based on the first portion of the first media content segment (e.g., the portion of the first media content segment requested/received at block 220). That is, concurrent with the request/receipt of the first media content segment in the first direction (e.g., from the beginning of the media content segment forward, such as is requested via network connection ‘A’ as shown in FIG. 3), the same media content segment can be requested in another direction. For example, in certain implementations, the same media content segment can be requested sequentially (e.g., byte by byte) starting from the end of the media content segment and progressing backwards (e.g., towards the beginning of the segment). For example, as shown in FIG. 3, upon receiving a selection of media content item 141A, while a media content segment (e.g., segment ‘A’) is requested/received in a particular direction (e.g., from the beginning of the segment forward) via network connection ‘A’ (e.g., a WiFi connection), the same media content segment can be requested/received in another direction (e.g., from the end of the same segment backward) via network connection ‘B’ (e.g., a 3G/4G cellular connection). In doing so, at least a portion of the segment (e.g., portion A2 of segment ‘A,’ as depicted in FIG. 3) can be requested and/or received via network connection ‘B’ while another portion is requested/received via network connection ‘A.’

It should be noted that various techniques can be similarly employed with respect to the referenced sequential request/transfer of the media content segment in a particular direction (e.g., backwards). While in certain implementations such a segment can be transferred in a backwards sequence, such as byte-by-byte (e.g., transferring a media content segment ‘abcdefghijklmn’ as ‘nmlkjihgfedcba,’ where each letter represents a byte of the content segment, in other implementations sets of multiple bytes (and/or any other such unit) can be requested/transferred in a forward sequence with respect to the set, but in a backwards sequence with respect to the segment as a whole. Thus, for example, for a content segment ‘abcdefghijklmn,’ three byte sets can be transferred in a forward direction, beginning with the end of the segment and moving forwards, e.g., ‘lmn’ followed by ‘ijk,’ ‘fgh,’ etc.

Additionally, in certain implementations, a second portion of the first media content segment can be requested/received from a second media source (e.g., a media source other than the media source from which the first portion of the first media content segment is requested/received, e.g., at block 220), such as via the second network connection. That is, in implementations in which multiple copies of the same media content item (e.g., media content item 141A as shown in FIG. 3) are stored on multiple servers (e.g., server machine 120A and server machine 120B can both store the same media content items), the referenced portion of the media content segment being received (e.g., via network connection ‘B’) may be requested/received from one of such servers (e.g., server machine 120B). It can be appreciated that, in such a scenario, different portions of the same media content segment (e.g., segment ‘A’) may be received from different media sources (e.g., servers 120A and 120B) via different network connections (e.g., network connection ‘A’ and network connection B′). In doing so, different requests (even for the same media content segment) can be provided to different servers, thereby decreasing the processing/transmission overhead associated with a particular connection/server and increasing the efficient processing of such requests.

At block 240, a transfer speed of the first network connection can be computed. For example, having requested/received (e.g., at block 220) at least a portion of a media content segment via one network connection (e.g., network connection ‘A’), the transfer speed of such a network connection can be computed (e.g., with respect to the transfer of the portion of the media content segment). In one aspect, block 240 is performed by multi-network content request engine 130.

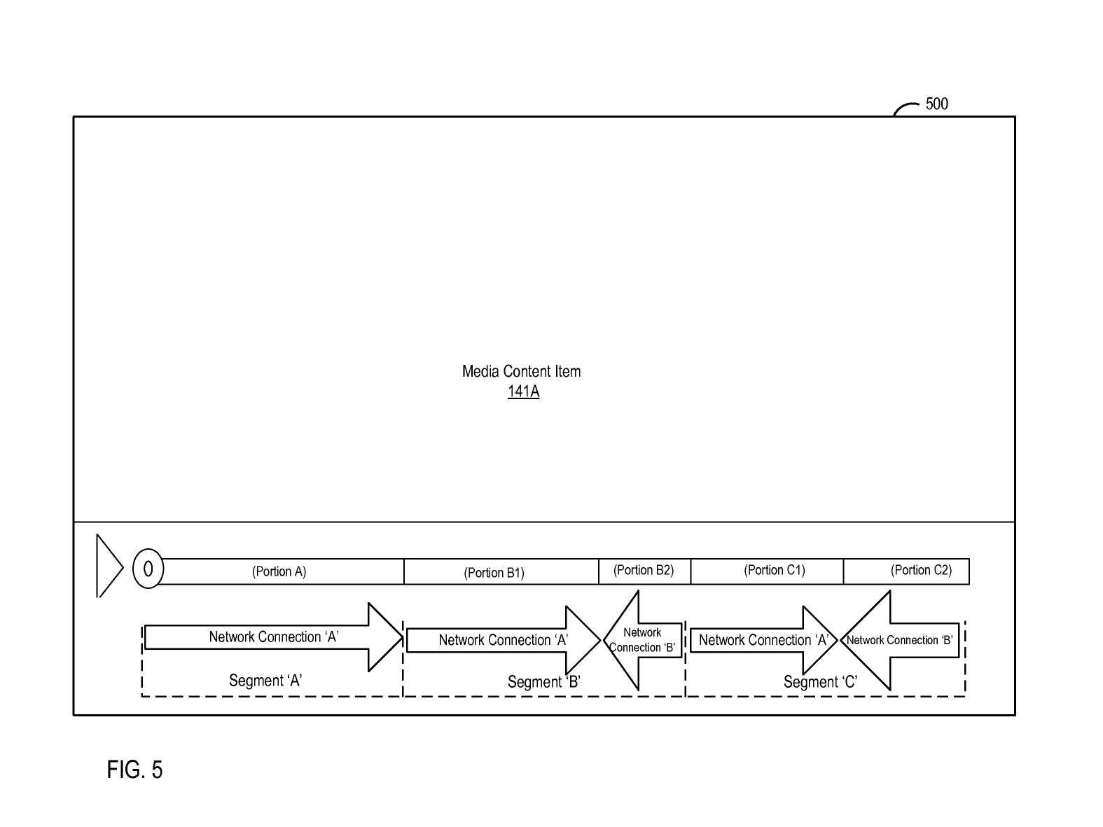

Moreover, in certain implementations a sequential transfer of a first media content segment in a second direction can be requested (e.g., as described at block 230) based on a determination that a transfer speed of the first network connection is below a defined threshold. By way of illustration, FIG. 5 depicts an exemplary media player 500 (e.g., a media player embedded and/or otherwise incorporated within a webpage, a standalone media player application that can execute on a mobile device, etc.) in which media content item 141A has been selected to be played. As shown in FIG. 5, an initial segment of the media content item (and/or a portion thereof) can be requested/received via one network connection (e.g., network connection ‘A,’ such as a WiFi connection). The speed of such a network connection can be monitored/computed on a periodic and/or ongoing basis, such as is described herein. In certain implementations, so long as the network connection (e.g., network connection ‘A’) can be determined to be sufficiently fast in order to provide a suitable user experience (e.g., fast enough so that the media can be viewed by the user without resulting in loading/buffering delays), subsequent segments (and/or portions thereof) can also be requested/received via the same network connection. However, in certain implementations, upon determining that a transfer speed (and/or any number of other connectivity metrics, e.g., latency) of the first network connection has fallen below (and/or is likely to fall below) a defined threshold (e.g., a threshold below which loading/buffering delays are likely), a sequential transfer of the media content segment in a second direction can be requested (e.g., as described at block 230). Thus, for example, as shown in FIG. 5, while segment ‘A’ of the media content item can be requested/received from network connection ‘A, in a scenario in which during the requesting/receiving of segment ‘B’ it is determined that the speed of network connection ‘A’ has fallen below a certain threshold, a sequential transfer of the media content segment (e.g., segment ‘B’) in a second direction can be requested requested/received via network connection ‘B,’ as shown. Having determined that the speed of network connection ‘A’ has fallen below a certain threshold, a sequential transfer of a subsequent media content segment (e.g., segment ‘C’) can be initiated substantially simultaneously from both network connection ‘A’ (e.g., in a first direction) and network connection ‘B’ (e.g., in a second direction), as shown. It should be noted that in scenarios in which one network connection (e.g., network connection ‘A’) can be subsequently determined to have improved such that it exceeds the referenced threshold, such a connection can be relied upon as a the sole source for data transfer, such as described with respect to segment ‘A.’ In doing so, multiple network connections can be utilized in scenarios in which the speed of one of the connections is determined to have fallen below a certain threshold, while a single network connection (e.g., WiFi) can be utilized when the speed of the connection is determined to be sufficient, thereby avoiding the consumption of additional resources (e.g., battery power, processing resources, etc.) which may be attendant with utilizing multiple network connections.

At block 250, a transfer speed of the second network connection can be computed. For example, having requested/received (e.g., at block 230) at least a portion of a media content segment via another network connection (e.g., network connection ‘B’), the transfer speed of such a network connection can be computed (e.g., with respect to the transfer of the portion of the media content segment). In one aspect, block 250 is performed by multi-network content request engine 130.

At block 260, the transfer speed of the first network connection (e.g., as computed at block 240) can be compared with the transfer speed of the second network connection (e.g., as computed at block 250). In doing so, a relatively faster network connection can be identified (e.g., among the various network connections). In one aspect, block 260 is performed by multi-network content request engine 130.

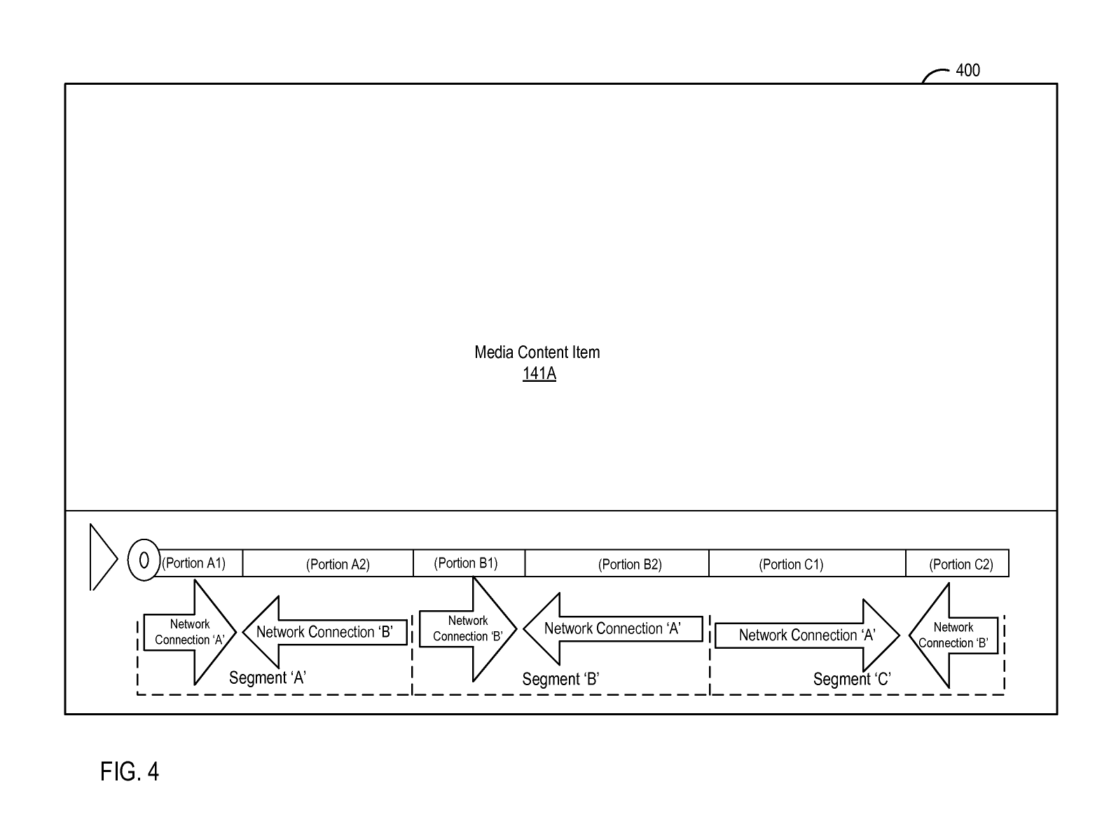

By way of illustration, FIG. 4 depicts an exemplary media player 400 (e.g., a media player embedded and/or otherwise incorporated within a webpage, a standalone media player application that can execute on a mobile device, etc.) in which media content item 141A has been selected to be played. As shown in FIG. 4, upon comparing the respective transfer speeds of network connection ‘A’ and network connection ‘B’ with respect to the transfer of segment ‘A’ of the media content item, it can be determined that network connection ‘B’ is the relatively faster network connection.

At block 270, a notification can be generated/provided. In certain implementations, such a notification can be generated with respect to/provided to the second media source (e.g., a media source other than the media source from which a portion of the media content segment was requested/received, such as a parallel server that also stores the same media content item). Moreover, in certain implementations such a notification can reflect and/or otherwise include the first portion of the first media content segment (e.g., the first portion of the first media content segment as requested/received at block 220). That is, being that multiple network connections/media sources can be utilized in order to request/receive a single media content item (and/or segments thereof), such as is described herein, it can be advantageous to provide one or more notifications (e.g., at periodic intervals and/or on an ongoing basis) that can serve to notify one media source of the extent to which the other media source has transferred content. For example, in a scenario in which server ‘A’ (which is transmitting a media content segment from beginning to end) has already transferred 2:00 minutes of a media content segment via network connection ‘A’, a notification can be generated/provided to server ‘B’ (which is transmitting the same media content segment from end to beginning via network connection ‘B’) reflecting that 2:00 minutes of the media content segment have been transmitted. Server ‘B’ can then account for this notification by stopping the transfer of content once the transfer can be determined to have reached the 2:00 minute mark (e.g., starting from the end of the segment and working backwards). In doing so, further efficiencies can be achieved by ensuring that additional bandwidth and/or any other such resources are not utilized with respect to the transmission of content that has already been provided to the content viewer device by the other media source. In one aspect, block 270 is performed by multi-network content request engine 130.

Additionally, in certain implementations, upon determining that a particular media content segment has been received via transfers from multiple network connections (such as in a manner described herein), such transfers can be terminated, e.g., by multi-network content request engine 130.

At block 280, a second media content segment can be requested. In certain implementations, such a second media content segment can be requested based on a determination that the first media content segment (e.g., the media content segment requested/received at blocks 220 and 230) has been received. That is, as described herein, a single media content segment can be requested/received substantially simultaneously via different network connections by requesting the sequential transfer of such a segment from one network connection in a first direction (e.g., from beginning to end) and the sequential transfer of the segment from another network connection in a different direction (e.g., from end to beginning). Accordingly, upon determining that the requested media content segment has been received (e.g., by determining that the respective sequential transfers of the referenced networks have ‘met’ at a point within the requested media content segment), another media content segment can be requested (e.g., segment ‘B,’ such as is depicted in FIGS. 3 and 4). In one aspect, block 280 is performed by multi-network content request engine 130.

Moreover, in certain implementations such a second media content segment can be requested from a first network connection and/or a second network connection. Additionally, in certain implementations a sequential transfer of the second media content segment in a first direction can be requested, such as from a relatively faster network connection (e.g., as identified at block 260). That is, it can be appreciated that different network connections may perform differently at different times and/or under different circumstances (e.g., with respect to mobile devices whose network connections may gain or lose quality, speed, etc., depending on location and other circumstances. Accordingly, the manner in which the various network connections are utilized to request/receive content may change from segment to segment.

By way of illustration, as shown in FIG. 4, segment ‘A’ was requested/received as a sequential transfer from beginning to end via network connection ‘A.’ However, it can be appreciated that network connection ‘B’ actually performed better (e.g., faster) than network connection ‘A’ (at least with respect to segment ‘A’). This determination can be accounted for when requesting/receiving a subsequent segment. For example, as shown in FIG. 4, based on a determination that network connection ‘B’ performed faster than network connection ‘A’ in transferring segment ‘A,’ network connection ‘B’ can be utilized to request/receive segment ‘B’ as a sequential transfer from beginning to end (which can reduce loading/buffering delays for the viewer), while network connection ‘A’ can be utilized to request/receive segment ‘B’ as a sequential transfer from end to beginning. Upon subsequently determining that network connection ‘A’ performed faster than network connection ‘B’ in transferring segment ‘B,’ network connection ‘A’ can be utilized to request/receive segment ‘C’ as a sequential transfer from beginning to end (which can reduce loading/buffering delays for the viewer), while network connection ‘B’ can be utilized to request/receive segment ‘C’ as a sequential transfer from end to beginning, as depicted in FIG. 4. In doing so, variability in the speed associated with respective network connections can be accounted for.

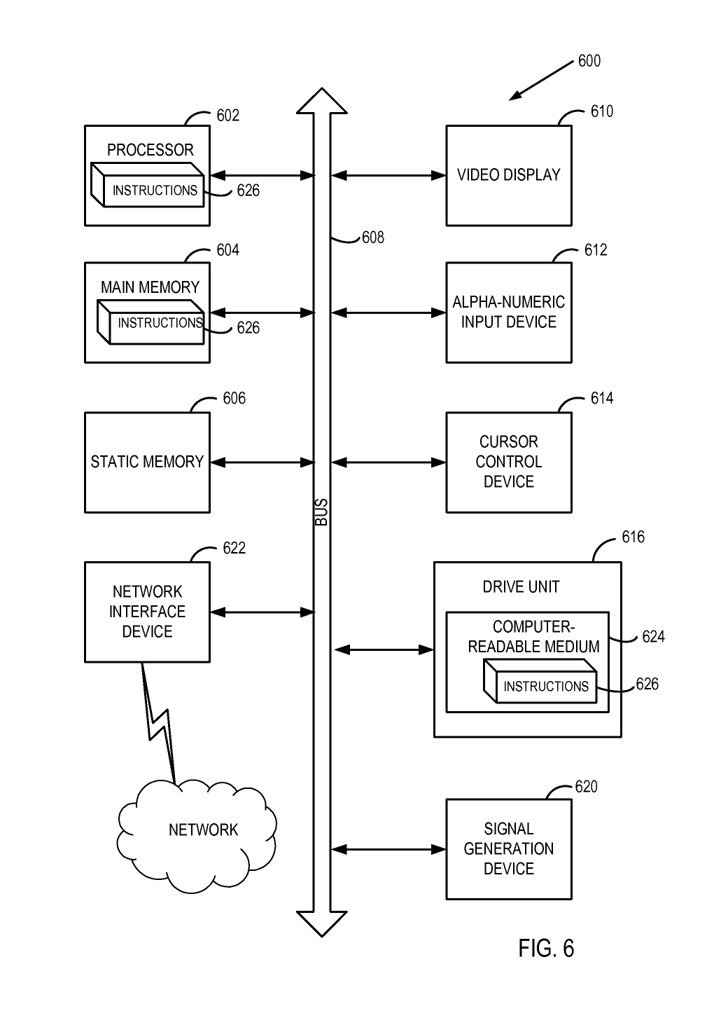

FIG. 6 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 (e.g., instructions executed by collaboration manager 225, etc.) embodying any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “requesting,” “computing,” “notifying,” “projecting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, media clips (e.g., images, audio clips, textual documents, web pages, etc.). The scope of the disclosure should, therefore, be determined with reference to the appended claims, along with the full scope of equivalents to which such claims are entitled.

What is claimed is:

1. A method comprising:
requesting, via a first network connection, a sequential transfer of a first media content segment in a first direction;
requesting, via a second network connection, a sequential transfer of the first media content segment in a second direction; and
based on a determination that the first media content segment has been received, requesting, by a processing device and from at least one of the first network connection or the second network connection, a second media content segment.

2. The method of claim 1, further comprising:
computing a transfer speed of the first network connection;
computing a transfer speed of the second network connection; and
comparing the transfer speed of the first network connection with the transfer speed of the second network connection to identify a relatively faster network connection;
wherein requesting a second media content segment comprises requesting a sequential transfer of the second media content segment in a first direction from the relatively faster network connection.

3. The method of claim 1, wherein a first portion of the first media content segment is received from a first media source via the first network connection and a second portion of the first media content segment is received from a second media source via the second network connection.

4. The method of claim 3, further comprising notifying the second media source of the first portion of the first media content segment.

5. The method of claim 3, wherein requesting a sequential transfer of the first media content segment in a second direction comprises requesting, based on the first portion of the first media content segment, a sequential transfer of the first media content segment in a second direction.

6. The method of claim 1, further comprising projecting a transfer speed of at least one of the first network connection or the second network connection.

7. The method of claim 6, wherein requesting a sequential transfer of a first media content segment in a first direction comprises requesting a sequential transfer of a first media content segment in a first direction based on a projected transfer speed of at least one of the first network connection or the second network connection.

8. The method of claim 1, wherein requesting a sequential transfer of the first media content segment in a second direction comprises requesting a sequential transfer of the first media content segment in a second direction based on a determination that a transfer speed of the first network connection is below a defined threshold.

9. A system comprising:
a memory; and
a processing device, coupled to the memory, to:
request, via a first network connection, a sequential transfer of a first media content segment in a first direction;
request, via a second network connection, a sequential transfer of the first media content segment in a second direction; and
based on a determination that the first media content segment has been received, request, from at least one of the first network connection or the second network connection, a second media content segment.

10. The system of claim 9, wherein the processor is further to:
compute a transfer speed of the first network connection;
compute a transfer speed of the second network connection; and
compare the transfer speed of the first network connection with the transfer speed of the second network connection to identify a relatively faster network connection;
wherein to request a second media content segment is to request a sequential transfer of the second media content segment in a first direction from the relatively faster network connection

11. The system of claim 9, wherein a first portion of the first media content segment is received from a first media source via the first network connection and a second portion of the first media content segment is received from a second media source via the second network connection.

12. The system of claim 11, wherein the processor is further to notify the second media source of the first portion of the first media content segment.

13. The system of claim 11, wherein to request a sequential transfer of the first media content segment in a second direction is to request, based on the first portion of the first media content segment, a sequential transfer of the first media content segment in a second direction.

14. The system of claim 9, wherein the processor is further to project a transfer speed of at least one of the first network connection or the second network connection.

15. The system of claim 14, wherein to request a sequential transfer of a first media content segment in a first direction is to request a sequential transfer of a first media content segment in a first direction based on a projected transfer speed of at least one of the first network connection or the second network connection.

16. The system of claim 9, wherein to request a sequential transfer of the first media content segment in a second direction is to request a sequential transfer of the first media content segment in a second direction based on a determination that a transfer speed of the first network connection is below a defined threshold

17. A computer readable medium having instructions stored thereon that, when executed by a processor, cause the processor to perform operations comprising:
requesting, via a first network connection, a sequential transfer of a first media content segment in a first direction;
requesting, via a second network connection, a sequential transfer of the first media content segment in a second direction; and
based on a determination that the first media content segment has been received, requesting, from at least one of the first network connection or the second network connection, a second media content segment.

18. The computer readable medium of claim 17, further comprising:
computing a transfer speed of the first network connection;
computing a transfer speed of the second network connection; and
comparing the transfer speed of the first network connection with the transfer speed of the second network connection to identify a relatively faster network connection;
wherein requesting a second media content segment comprises requesting a sequential transfer of the second media content segment in a first direction from the relatively faster network connection.

19. The computer readable medium of claim 17, wherein a first portion of the first media content segment is received from a first media source via the first network connection and a second portion of the first media content segment is received from a second media source via the second network connection.

20. The computer readable medium of claim 19, further comprising notifying the second media source of the first portion of the first media content segment.

21. The computer readable medium of claim 19, wherein requesting a sequential transfer of the first media content segment in a second direction comprises requesting, based on the first portion of the first media content segment, a sequential transfer of the first media content segment in a second direction.

22. The computer readable medium of claim 17, further comprising projecting a transfer speed of at least one of the first network connection or the second network connection, wherein requesting a sequential transfer of a first media content segment in a first direction comprises requesting a sequential transfer of a first media content segment in a first direction based on a projected transfer speed of at least one of the first network connection or the second network connection.
